(19) United States
(12) Patent Application Publication
(10) Pub. No.: US 2025/0250118 A1
(43) Pub. Date: Aug. 7, 2025

(54) SPLIT SPROCKET ASSEMBLY FOR CONVEYOR DRIVE ARRANGEMENT AND RELATED METHODS

(71) Applicant: SPAN TECH LLC, Glasgow, KY (US)

(72) Inventors: Stephen C. Fye, Glasgow, KY (US); Carlos Ivan Sierra Sierra Manzo, Bowling Green, KY (US)

(21) Appl. No.: 19/043,442

(22) Filed: Feb. 1, 2025

Related U.S. Application Data
(60) Provisional application No. 63/627,843, filed on Feb. 1, 2024.

(51) Int. Cl. B65G 23/06

(52) U.S. Cl. CPC B65G 23/06

(57) ABSTRACT

A split sprocket assembly for connecting to a drive shaft for driving a conveyor chain is disclosed. The split sprocket assembly includes first and second sprocket portions adapted for mating together along the drive shaft. The second sprocket portion includes integral connectors that form a releasable locking engagement with receivers in the first sprocket portion. A method of forming a drive for a conveyor using a drive shaft is also disclosed, which includes forming a releasable locking engagement between first and second sprocket portions over the drive shaft. The releasable locking engagement may be a snap-fit engagement.

### CROSS-REFERENCE TO OTHER APPLICATIONS

This application is related to International Patent Application No. PCT/US2011/036397, filed May 13, 2011, which claims the benefit of U.S. Provisional Patent Application No. 61/334,297, filed May 13, 2010, and is also related to U.S. Pat. No. 6,959,803, the full disclosures of which are incorporated herein by reference. This application also claims the benefit of U.S. Provisional Patent Application No. 63/627,843, filed Feb. 1, 2024.

### TECHNICAL FIELD

This disclosure relates generally to driving a conveyor and, more particularly, to a split sprocket assembly which may be used in connection with a drive for a conveyor.

### BACKGROUND

In the past, modular link conveyors have typically been driven by a drive including a plurality of laterally spaced, gang-driven sprockets located at the transition of the conveyor from the forward to the return run. Despite the longstanding success of this popular approach, it is not without limits. For one, the sprockets are typically formed in split portions and assembled together using fasteners. This manner of assembly considerably increases the effort required to manufacture the conveyor, and also increases the difficulty of replacing the sprocket if it becomes excessively worn or damaged. Conveyor downtime is a considerable source of loss in today's modern manufacturing or distribution facility, thus downtime is to be avoided at all reasonable costs.

Accordingly, there is a need for an improved drive for a conveyor. The drive should be readily adaptable to many different types of conveyors at minimal cost, and potentially applied in a retrofit situation without extensive effort. The drive would also be able to be serviced quickly and inexpensively to reduce conveyor downtime and maximize efficient operation of the conveyor. Overall, a considerable increase in productivity and a reduction in cost in terms of conveyor assembly, operation, and maintenance would be realized as a consequence.

### SUMMARY

In one aspect, this disclosure relates to a split sprocket assembly for connecting to a driveshaft for driving a conveyor chain. The split sprocket assembly may comprise first and second sprocket portions adapted for mating together along the drive shaft. The second sprocket portion may further include integral connectors for forming a releasable locking engagement with receivers in the first sprocket portion. This releasable locking engagement may be a snap-fit engagement. The split sprocket assembly may further include a recess for releasing the locking engagement, which may comprise a slot between each integral connector and the associated receiver. The integral connectors may be arcuate and include projections at a distal end thereof for engaging with the receivers. The first sprocket portion may further include a plurality of opposed ramps that increase progressively in height in a tangential direction.

Additionally, the connectors may form a portion of a hub of the sprocket, wherein the second sprocket portion comprises a greater portion of a circumference of the hub than the first sprocket portion. The first and second sprocket portions may include a plurality of teeth projecting outwardly in a radial direction and arranged in spaced rows with the recessed hub therebetween.

At least one of the first and second sprocket portions may be adapted for mechanically engaging the drive shaft by way of a coupler. To achieve this engagement, an inner surface of at least one of the first and second sprocket portions may be provided with a radially extending projection adapted to be received in an associated bore in the drive shaft.

In some embodiments, a conveyor may be provided which includes the split sprocket assembly.

In some embodiments, the first and second sprocket portions may be formed of a durable polymer material.

A further aspect of the disclosure relates to a split sprocket assembly for connecting to a drive shaft for driving a conveyor chain. The split sprocket assembly may comprise first and second sprocket portions adapted for mating together over the drive shaft by way of a snap-fit engagement. The second sprocket portion may include integral connectors for forming the snap-fit engagement with receivers in the first sprocket portion.

Yet another aspect of the disclosure relates to a method of forming a drive for a conveyor using a drive shaft. The method may comprise forming a releasable locking engagement between first and second sprocket portions over the drive shaft. The releasable locking engagement may comprise a snap-fit engagement. The method may further include urging a projection of the second sprocket portion towards a receiver of the first sprocket portion.

In some embodiments, the method may further include coupling the first and second sprocket portions to the drive shaft via at least one pin projecting inward from an inner surface of the first and second sprocket portions.

These and additional features provided by the embodiments described herein will be more fully understood in view of the following detailed description, in conjunction with the drawings.

### BRIEF DESCRIPTION OF THE DRAWINGS

While the specification concludes with claims which particularly point out and distinctly claim this technology, it is believed this technology may be better understood from the following description of certain examples taken in conjunction with the accompanying drawings, in which like reference numerals identify the same elements and in which:

FIG. 1 is a side schematic view of a conveyor;

FIG. 1A is a cross-sectional view of a chain formed of links;

FIG. 1B is a cross-sectional view of the links of FIG. 1A connected in a snap-fit engagement in a first position;

FIG. 1C is a cross-sectional view of the links of FIG. 1A connected in the snap-fit engagement in a second position;

FIG. 1D is a bottom perspective view of the conveyor;

FIG. 2 is a perspective view of the split sprocket assembly, further including a first sprocket portion and a second sprocket portion;

FIG. 2A is a perspective view of the first sprocket portion;

FIG. 2B is a perspective view of the second sprocket portion;

FIG. 3 is a cross-sectional view of the split sprocket assembly;

FIG. 4 is an exploded view of the split sprocket assembly and a shaft;

FIG. 4A is a perspective view of the split sprocket assembly coupled to the shaft of FIG. 4;

FIG. 4B is a cross-sectional view of the shaft of FIG. 4;

FIG. 4C is a cross-sectional view of the split sprocket assembly separated from the shaft of FIG. 4; and

FIG. 4D is a cross-sectional view of the split sprocket assembly coupled to the shaft of FIG. 4.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

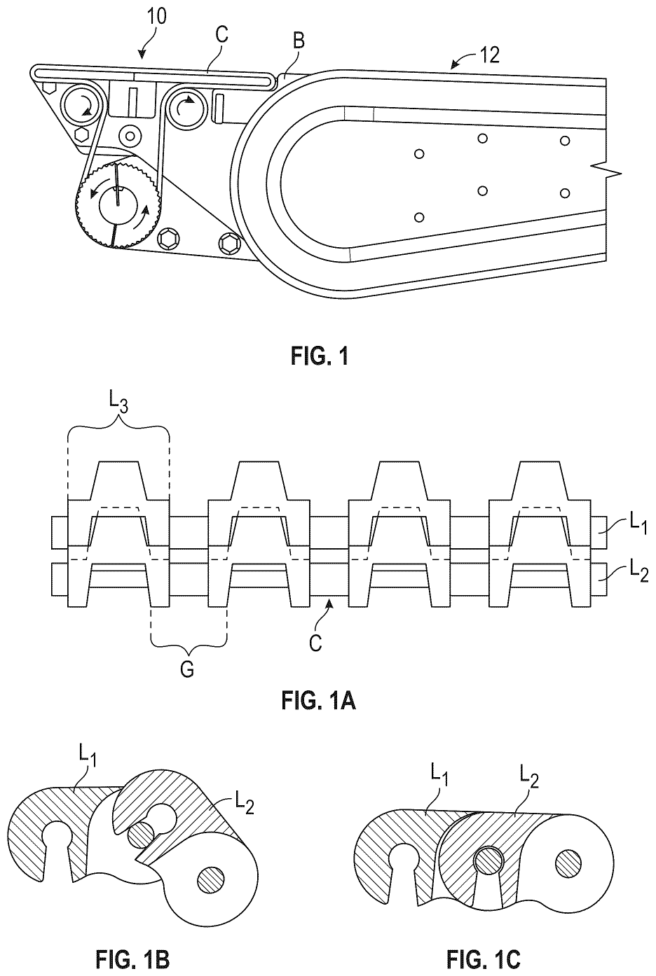

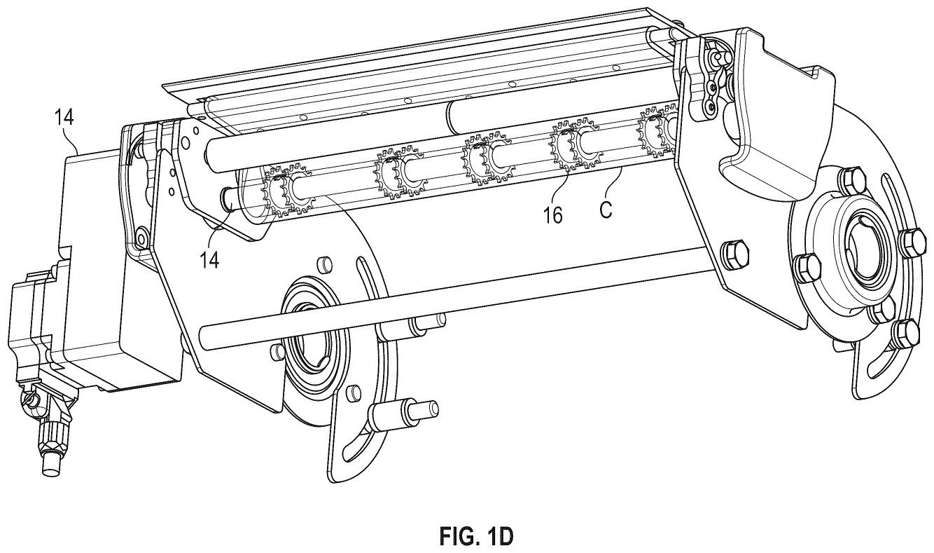

With reference to the side schematic view of FIG. 1, a conveyor 10 constructed in accordance with one embodiment of the present invention is disclosed. The conveyor 10 may be positioned adjacent to a discharge end of a first conveyor 12 and an infeed end of a second, adjacent conveyor (not shown) and functions to assist articles being conveyed in making the transition between the two conveyors. The conveyor 10 may be called a “transfer conveyor” in the vernacular. The first conveyor 12 is of the endless variety and, thus, includes a continuous belt made of fabric, rubber, link, etc., a modular link chain, or a like structure that transitions from a forward to a return run adjacent to one end of the conveyor 10. The conveyor 10 also includes a conveying medium, such as a belt or chain C, which may be of the type disclosed in PCT/US03/05666, the disclosure of which is incorporated herein by reference. An example of one type of chain C formed of links is shown in FIGS. 1A-1C. As shown in the figures, links L1, L2 connect in a snap-fit fashion and include laterally repeating sections L3 defining gaps G. A bridge B, which is sometimes called a finger plate, finger bar, comb, etc., may also be provided for assisting articles being conveyed in making the transition from the adjacent first conveyor 12 to the conveyor 10, and may be considered a single conveyor.

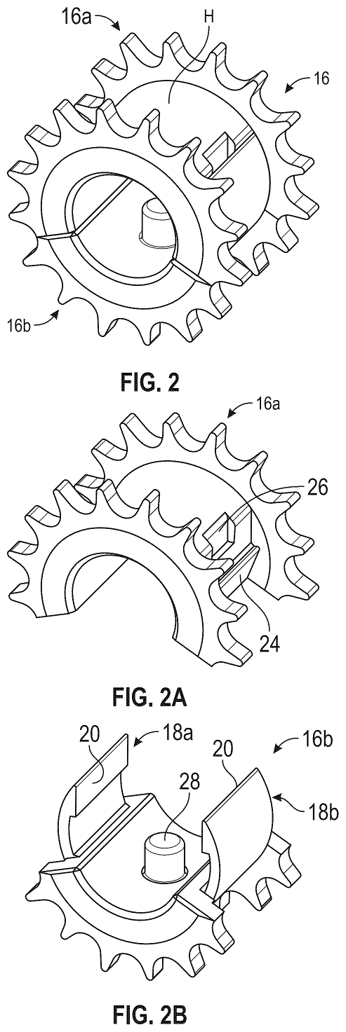

With reference to the bottom perspective view of FIG. 1D, it can be understood that the chain C associated with the conveyor 10 may be driven by a motor M, which in turn rotates a shaft 14 including one or more sprockets 16. According to one aspect of the disclosure, and with reference to FIGS. 2, 2A, and 2B, the one or more sprockets 16 may comprise a modular, or “split” sprocket 16, which is comprised of two or more portions interconnected by a releasable connection.

In the illustrated example, the sprocket 16 comprises a first portion 16a which forms a minority of a circumference of a hub H when assembled, and a second portion 16b, which comprises a majority of the circumference of the hub H. However, it is possible for the sprocket portions 16a, 16b to have relative dimensions other than as shown. Each sprocket portion 16a, 16b includes a plurality of teeth T projecting outwardly in a radial direction, which may be arranged in spaced rows with the hub H therebetween.

As can be understood from FIG. 2B, the second portion 16b is adapted for forming a releasable connection with the first portion 16a. In the illustrated example, this is achieved by providing the second portion 16b with a bifurcated construction. Specifically, the second portion 16b includes opposed connectors 18a, 18b as part of the hub H between the rows of teeth T, which may extend in the radial direction beyond an outer surface of the hub.

The opposed connectors 18a, 18b may be integrally formed and extend along an arc corresponding to the circumference of the sprocket 16 and the hub H in particular, such that outer surfaces of the connectors 18a, 18b partially form the outer surface of the hub. At or near a distal end, each of the opposed connectors 18a, 18b includes a projection 20 extending radially inwardly so as to form a ledge, and corresponding receivers 22 are provided on the first portion 16a of the sprocket 16, adjacent to which are opposed ramps 24.

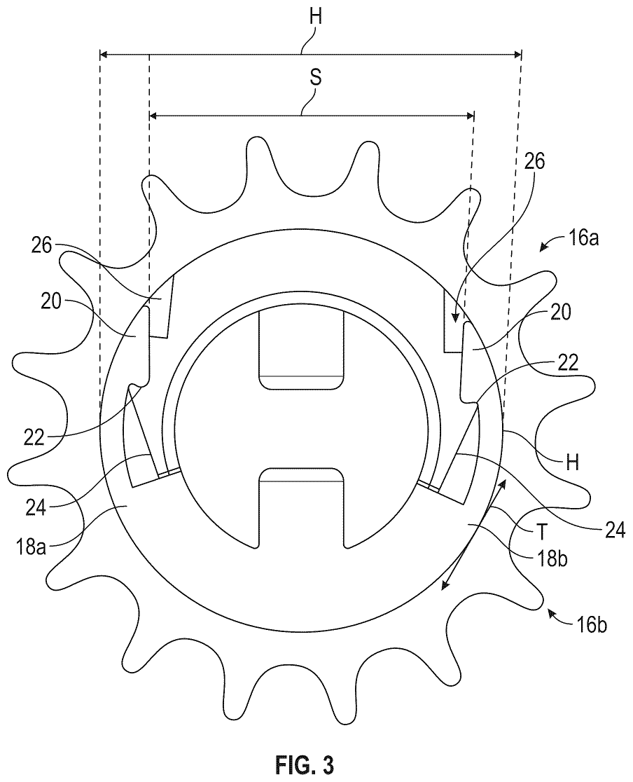

With reference now to FIG. 3, an inner spacing S between the opposed projections 20 is less than a nominal outer diameter D of the hub H. Furthermore, surfaces of the opposed ramps 24 increase progressively in height in a tangential direction T. The increase starts from a minimum at an innermost end and extends to a maximum adjacent to an edge of each receiver 22.

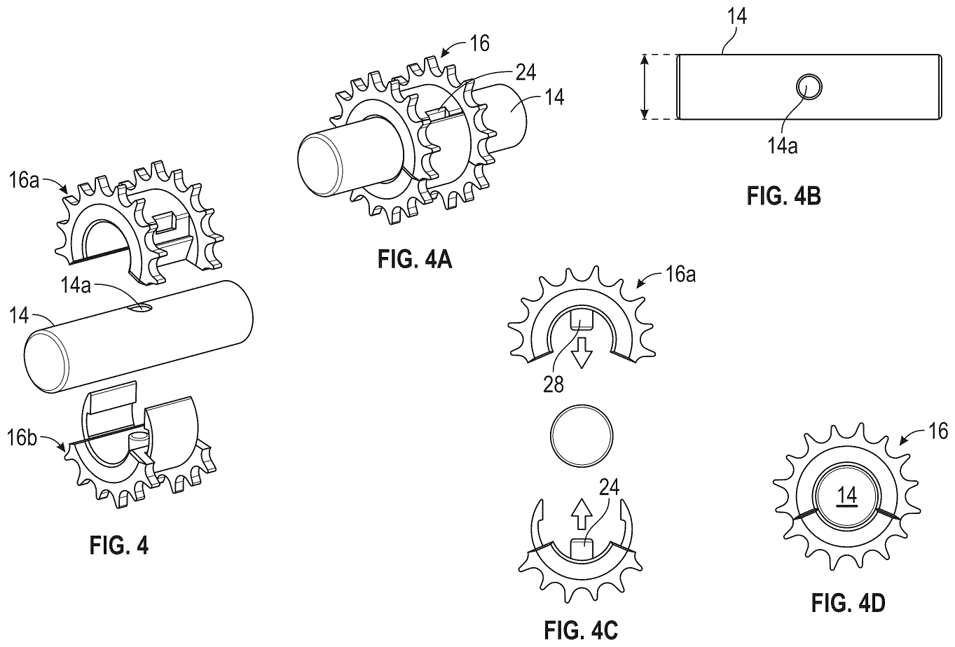

Thus, with reference to FIGS. 4-4D, it can be understood that the sprocket 16 may be formed by interconnecting the first and second sprocket portions 16a, 16b. Specifically, in the orientation shown (which is exemplary only), the second or lower portion 16b is urged toward the first or upper portion 16a. This urging continues until a leading edge of each projection 20 engages a lower extent of a corresponding ramp 24. Continued urging or compression among the now-engaged first and second portions 16a, 16b causes the projections 20 to move along the ramps 24 and, in view of the progressive increase in a surface height thereof, the connectors 18a, 18b are caused to flex radially outwardly. This flexing continues until a terminal end of each ramp 24 is reached, at which point an inherent biasing of the connectors 18a, 18b causes the projection 20 to enter the corresponding receiver 22. A secure locking, but releasable, engagement thus results, which may be considered a snap-fit engagement that does not require the use of separate fasteners or tools to form.

In order to release the snap-fit engagement, the connectors 18a, 18b may be urged outwardly to lift the projection 20 from a seated condition in the receiver 22. This may be facilitated by the presence of a recess 26 forming a space between the face of the projection 20 and the opposing, generally parallel face of the receiver 22. The recess 26 may be sized and shaped for receiving an elongated tool, such as a flat-head screwdriver, which may be twisted to facilitate the movement of the connectors 18a, 18b and hence the release.

Torque transmission between the sprocket 16 and an associated shaft 14 may be facilitated by a coupling. In the illustrated embodiment, each sprocket portion 16a, 16b is provided with a radially extending projection, such as a pin 28, that is adapted to be received in an associated bore 14a in the shaft 14. The connection thus ensures reliable torque transmission, and may also function as a shear pin to decouple the sprocket 16 in the event of excessive torque to avoid a catastrophic failure of the associated conveyor 10.

The sprocket portions 16a, 16b may be formed of a durable material, such as a polymer, and in particular nylon. The portions need not be made of the same material, as the second portion 16b including the connectors 18a, 18b has enhanced requirements in terms of flexibility as compared to the first portion 16a.

Each of the following terms written in singular grammatical form: “a”, “an”, and the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or the context clearly dictates otherwise. For example, the phrases: “a unit”, “a device”, “an assembly”, “a mechanism”, “a component, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated components), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase “consisting essentially of” Each of the phrases “consisting of” and “consists of, as used herein, means “including and limited to”. The phrase “consisting essentially of” means that the stated entity or item (system, system unit, system sub-unit device, assembly, sub-assembly, mechanism, structure, component element or, peripheral equipment utility, accessory, or material, method or process, step or procedure, sub-step or sub-procedure), which is an entirety or part of an exemplary embodiment of the disclosed invention, or/and which is used for implementing an exemplary embodiment of the disclosed invention, may include at least one additional feature or characteristic” being a system unit system sub-unit device, assembly, subassembly, mechanism, structure, component or element or, peripheral equipment utility, accessory, or material, step or procedure, sub-step or sub-procedure), but only if each such additional feature or characteristic” does not materially alter the basic novel and inventive characteristics or special technical features, of the claimed item.

Terms of approximation, such as the terms about, substantially, approximately, generally, etc., as used herein, refer to ±10% of the stated numerical value or as close as possible to a stated condition.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment may also be illustratively described and presented in the context or format of a plurality of separate embodiments.

Although the invention has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A split sprocket assembly for connecting to a drive shaft for driving a conveyor chain, comprising:
first and second sprocket portions adapted for mating together along the drive shaft, the second sprocket portion including integral connectors adapted to flex outwardly in a radial direction to be received by the first sprocket portion.

2. The split sprocket assembly according to claim 1, wherein each connector is adapted to engage with a corresponding receiver in the first sprocket portion and form a releasable locking engagement.

3. The split sprocket assembly according to claim 2, wherein the releasable locking engagement comprises a snap-fit engagement.

4. The split sprocket assembly according to claim 2, wherein the integral connectors are arcuate and include projections at a distal end thereof for engaging with the receivers.

5. The split sprocket assembly according to claim 2, further including a recess for releasing the locking engagement.

6. The split sprocket assembly according to claim 5, wherein the recess comprises a slot between the integral connector and the corresponding receiver of the first sprocket portion.

7. The split sprocket assembly according to claim 1, wherein at least one of the first and second sprocket portions is adapted for mechanically engaging the drive shaft by way of a coupler.

8. The split sprocket assembly according to claim 7, wherein the coupler comprises a radially extending projection adapted to be received in an associated bore in the drive shaft.

9. The split sprocket assembly according to claim 1, wherein the integral connectors form a portion of a hub of the split sprocket assembly.

10. The split sprocket assembly according to claim 9, wherein the second sprocket portion comprises a greater portion of a circumference of the hub than the first sprocket portion.

11. The split sprocket assembly according to claim 1, wherein the first sprocket portion includes a plurality of opposed ramps that increase progressively in height in a tangential direction.

12. The split sprocket assembly according to claim 11, wherein projections of the integral connectors move along the plurality of opposed ramps until a terminal end of each ramp is reached and the projections enter receivers.

13. The split sprocket assembly according to claim 1, wherein the first and second sprocket portions are formed of a durable polymer material.

14. The split sprocket assembly according to claim 1, wherein the first and second sprocket portions include a plurality of teeth projecting outwardly in a radial direction and arranged in spaced rows with a recessed hub therebetween.

15. A conveyor including the split sprocket assembly of claim 1.

16. A split sprocket assembly for connecting to a drive shaft for driving a conveyor chain, comprising:
first and second sprocket portions adapted for mating together over the drive shaft by way of a snap-fit engagement, wherein the first and second sprocket portions form a hub of the split sprocket assembly adapted for receiving the drive shaft.

17. The split sprocket assembly of claim 16, wherein the second sprocket portion includes integral connectors for forming the snap-fit engagement with receivers in the first sprocket portion.

18. A method of forming a drive for a conveyor using a drive shaft, comprising:
connecting first and second sprocket portions to the drive shaft, the second sprocket portion including integral connectors adapted to flex outwardly in a radial direction to receive the first sprocket portion.

19. The method of claim 18, further including the step of coupling the first and second sprocket portions to the drive shaft via at least one pin projecting inward from an inner surface of the first and second sprocket portions.

20. The method of claim 18, further including the step of releasing the first and second sprocket portions from each other by lifting up on the integral connectors.
